(19) United States
(12) Patent Application Publication
(10) Pub. No.: US 2003/0223919 A1
(43) Pub. Date: Dec. 4, 2003

(54) Integrated thermoelectric power generator and catalytic converter

(76) Inventors: Sehoon Kwak, Auburn Hills, MI (US); Christopher A. Willner, Rochester, MI (US); George Konstantakopoulos, Birmingham, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/158,654

(22) Filed: May 30, 2002

(51) Int. Cl. F01N 3/10; B01D 53/34

(52) U.S. Cl. 422/174; 422/173; 422/177

(57) ABSTRACT

A supplemental energy generating system is integrated with an exhaust system of a combustion engine. The system includes a thermoelectric generator (TEG) having a housing enclosing a metal catalytic substrate positioned in an exhaust passage of the exhaust system. A coolant channel is disposed with the housing having an input and output connected to an externally located cooling system, and at least one thermoelectric generator element is disposed within the housing between the coolant channel and the metal catalytic substrate. The thermoelectric generator element is positioned to be in heat exchange relationship with the metal catalytic substrate and the coolant channel, and generates harvestable electric power as a function of the heat exchange process.

### BACKGROUND OF THE INVENTION

1. Field of the Invention

The present invention relates to improving vehicle fuel efficiency by integrating an electric power generating system into an engine exhaust system.

2. Background Art

In general, internal combustion engines, such as used in automobiles, are inherently inefficient with respect to utilization of energy. Typically, 70% of an engine's initial energy, e.g., gasoline or diesel fuel, is lost to the environment in the form of heat energy. Most of this heat energy is ported to the environment by either the engine's radiator/coolant or the exhaust gas. As a consequence, recovery of even a portion of the lost heat energy can improve vehicle efficiency and fuel economy.

To date, attempts have been made to use a thermal to electric conversion arrangement to recover the heat energy lost from a vehicle's exhaust gas. In one arrangement, a 1 kilowatt generator was used with a diesel engine. The system was relatively large and used bismuth telluride thermoelectric devices. Another arrangement provided 0.2 kilowatt generator for a gasoline engine. The latter system was relatively compact and used lead telluride thermoelectric devices. With both systems, the flow of exhaust gas from the engine was altered to increase heat transfer from the exhaust gas to the thermoelectric devices/modules to a suitable level. However, altering an engine's exhaust flow can potentially increases backpressure, which in turn will negatively impact engine performance.

In another arrangement disclosed in U.S. Pat. No. 5,968,456 to Parise, a thermoelectric power generator is provided with a catalytic converter to allow the energy of exothermic reactions in the catalytic converter to produce electrical energy. The thermoelectric power generator is also arranged with a controller to allow selective use as a heat pump to preheat the catalytic converter and reduce light-off time at cold start. However, the arrangement disclosed in U.S. Pat. No. 5,968,456 utilizes a ceramic catalytic monolith, which can have relatively low heat conduction capability, higher specific heat coefficient requiring longer periods of time to reach high enough temperatures for high efficiency thermoelectric operation, and is susceptible to thermal and mechanical shocks.

As a consequence, a need still exists for an arrangement capable of higher efficiency in recovering heat energy lost from a vehicle's exhaust without negatively impacting engine performance.

### SUMMARY OF THE INVENTION

Accordingly, the present invention provides an integrated thermoelectric generator and catalytic converter arrangement having a thermoelectric device in heat transfer relationship with a metallic substrate to improve conversion efficiency and performance without altering an engine's exhaust flow/backpressure.

In accordance with one aspect of the present invention, a supplemental energy generating system integrated with an exhaust system of a combustion engine is provided having a catalytic converter positioned in an exhaust passage of the exhaust system. The converter includes a housing enclosing a metal catalytic substrate. A coolant channel is disposed with the housing having an input and output connected to an externally located cooling system, and a thermoelectric generator element is disposed within the housing between the coolant channel and the metal catalytic substrate. The thermoelectric generator element is positioned to be in heat exchange relationship with the metal catalytic substrate and the coolant channel, and generate an electric current as a function of the heat exchange. A processing system is connected to the thermoelectric generator element for processing the electric current to generate an electric power output.

The integrated thermoelectric catalytic converter uses the large surface area already present in the catalytic converter to enhance heat transfer from exhaust to the thermoelectric element. In addition, the catalytic converter acts as a thermal mass, which allows a more continuous generation of electricity than without a thermal mass. In further accord with the present invention, integration of a catalytic converter and thermoelectric element does not modify exhaust gas flow. Thus, backpressure is not altered, thereby producing no negative impact on engine performance.

The present invention will be more fully understood upon reading the following detailed description of the preferred embodiment(s) in conjunction with the accompanying drawings.

### BRIEF DESCRIPTION OF THE DRAWINGS

FIG. 1 is a block diagram of an engine coolant/exhaust system in accordance with an exemplary embodiment of the present invention;

FIG. 2 is a block diagram representing a crosswise cross section of a catalytic converter incorporating a thermoelectric power generator in accordance with the present invention;

FIG. 3 is a block diagram representing a crosswise cross section of a catalytic converter incorporating a thermoelectric power generator in accordance with the present invention;

FIG. 4 is a circuit diagram of subsequent power regulation incorporated into the present invention; and

FIG. 5 is a generalized schematic illustrating operation of a thermoelectric generator.

### DETAILED DESCRIPTION OF THE PREFERRED EMBODIMENT(S)

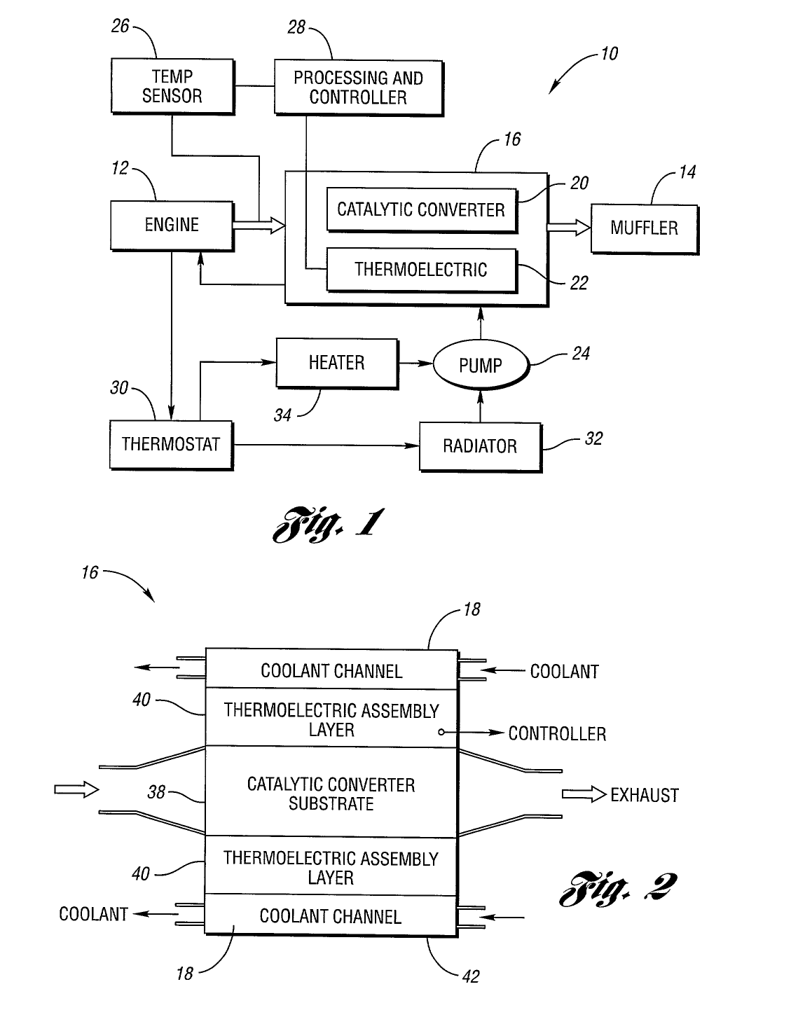

Referring to FIG. 1, a block diagram is provided illustrating a coolant/exhaust system 10 of an internal combustion engine incorporating a thermoelectric power generator arrangement in accordance with the present invention. More specifically, system 10 includes an internal combustion engine 12, and an exhaust system having a muffler 14 and an integrated thermoelectric generator/catalytic converter system (TEG) 16. As best seen in FIG. 2 and described more fully below, TEG 16 includes a housing enclosing a catalytic converter structure 20 and a thermoelectric power generating structure 22, as well as a coolant channel 18 coupled to an external coolant pump 24 via a coolant inlet and outlet on the housing. A temperature sensing arrangement 26 is also connected to the engine exhaust system and/or catalytic converter. The temperature sensing arrangement 26 provides a signal representative of exhaust or catalyst temperature for processing by a controller 28. Controller 28 can be a microprocessor-based control circuit. The engine cooling system also includes a thermostat 30, radiator 32, and heater 34 connected with engine 12 and pump 24 as is well understood in the art.

Referring now to FIG. 2, in accordance with the present invention, TEG 16 includes a thermoelectric power generating device 36 integrated into a layer structure of the catalytic converter 20 so as to be positioned for heat exchange with the engine exhaust/catalytic converter. As shown, TEG 16 is formed from three main components: a catalytic converter substrate core 38, a thermoelectric device/module assembly layer 40, and one or more cooling channel layers 18. Substrate core 38 is enclosed in a metal casing 42 and connected to an upstream and downstream exhaust pipe so that exhaust gases pass only through the catalytic converter core. The thermoelectric device/module assembly layer consists of one or more thermal to electric energy conversion devices and/or modules. If plural devices are used, the respective outputs are connected in series and/or parallel to produce a desired output of electrical power.

The thermoelectric device is isolated from the exhaust gas flow, coolant (liquid or gaseous) flow and ambient environment and has openings for electrical leads only. The electrical leads from the thermoelectric assembly are connected to the controller 28 and/or other electronic devices, such as battery, ultra-capacitor, DC/DC converter 44 (represented in FIG. 4), etc. The circuit diagram of FIG. 4 illustrates a representative electrical schematic for subsequent power regulation. The thermoelectric device(s) 36 are represented as having a temperature based resistance R_{S}(T) and producing an output current I_{S} and voltage V_{S}(α, I, T) coupled to DC/DC converter 44. The intended load is represented as R_{L}, and the output of DC/DC converter 44 is represented as I_{L} and V_{L}. V_{S}, I_{S}, V_{L}, and I_{L} are controlled variables. With such an arrangement, the electrical power generated by the thermoelectric device(s) is subsequently harvested by the controller or other processing circuit to provide electrical power to charge a battery or power other electrical components on the vehicle.

Within the thermoelectric assembly layer, the cold side of the thermoelectric device(s)/module(s) face the cooling channel. The cooling channel is comprised of a finned metallic and/or ceramic structure for enhanced heat transfer. As mentioned previously, the cooling channel has inlet and outlet openings to channel coolant from radiator 32 or other independent cooling system through the converter to remove heat energy from the cold side of the thermoelectric devices/modules. The independent cooling system may include a heat exchanging surface with ambient air, fan(s), pump(s), and/or hoses (metallic and/or polymer based).

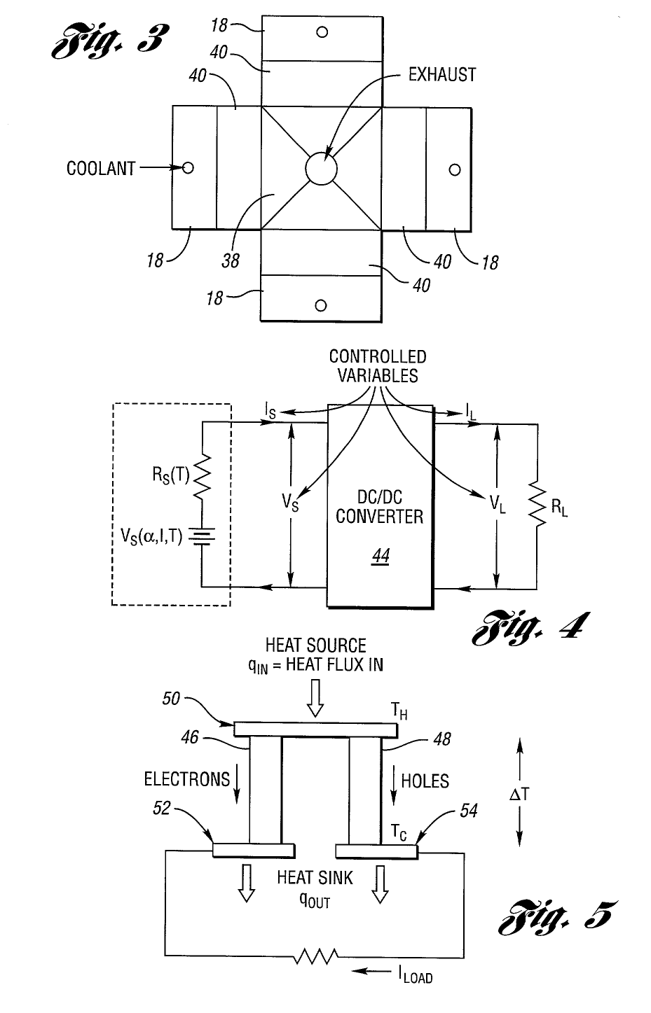

FIG. 3 shows the sandwiched construction of TEG 16 in crosswise cross section. TEG 16 may be constructed of a catalytic converter, thermal-to-electric energy converting devices and/or modules that utilize thermoelectric, thermionic, or electron tunneling phenomenon, and cooling channel.

In accordance with one aspect of the present invention, a metal catalytic substrate is used instead of a conventional catalytic monolith (ceramic) arrangement because a ceramic substrate has relatively low heat conduction capability in comparison with a metallic substrate. For example, cordierite (ceramic material) has a thermal conductivity of approximately 6 to 8 W/m K, whereas stainless steel has thermal conductivity of approximately 15 W/m K. Therefore, by using a metallic substrate, heat transfer from the exhaust gas to the thermoelectric device(s) is improved, which in turn, allows more energy to be harvested or recovered from the waste heat. In addition, the metallic substrate has a lower specific heat coefficient, thereby reducing the time needed to reach a sufficiently high enough temperature for high efficiency thermoelectric operation. The metallic substrate also has a higher resistance to thermal and mechanical shocks, and has a higher operational temperature range than a monolith catalyst.

In operation, at a cold engine start condition, TEG 16 is expected to be at ambient temperature. Thus, when controller 28 detects that the temperature of the catalytic converter is below a predetermined or light off temperature, operation of the thermoelectric device(s) is disabled, i.e., switched off, such that the TEG does not draw energy away from heating the catalytic converter. Since the thermoelectric materials are mostly insulators, the catalytic converter substrates will heat up comparatively faster than a catalytic converter without a layer of thermoelectric device/module assembly as long as the devices are not switched on.

Once the catalytic substrate material reaches the light off temperature, controller 28 then enables the thermoelectric devices to begin generating electrical power. More specifically, the temperature gradient between the hot and cold side of the thermoelectric device will induce electron flow, thus, creating electric current. To maintain flow of electric current, the thermoelectric devices/modules temperature gradient will be applied by cooling the cold side temperature with coolant (liquid or gaseous form). The coolant flow is controlled based on the temperature of the thermoelectric devices/modules cold side, and operational condition of the vehicle. The engine cooling system usually operates at 180° F., while an independent cooling system would likely operate at much lower temperature. In addition, when a vehicle is stopped, the catalytic converter remains hot for a period of time. Thus, the TEG can continue to generate electricity until the temperature of the hot side falls below the design or predetermined temperature.

The fundamental concept of a thermoelectric (TE) generator is based upon the Seebeck and Peltier effects, and results from the situation where a semiconductor junction (also called a thermoelectric unicouple) is subjected to a temperature gradient. An imbalance in the electrical carrier concentrations induces a flow of electric charge and a concomitant electrical potential. When the generator is mounted between a heat source and a cooling channel, electrical power on the order of several watts to several kilowatts can be produced depending upon particular design of such a system and the thermoelectric materials. Added value and reliability comes from the fact that thermoelectric devices require no moving parts and convert heat directly to electricity.

The effectiveness of a thermoelectric material for power generation purposes is determined by a dimensionless number called thermoelectric figure of merit (ZT) and by its power factor. In cooling application power factor is not as crucial as ZT. The thermoelectric figure of merit is defined as

$$\begin{matrix}ZT = \frac{{α}^{2} σ}{λ} T , & & λ = {λ}_{e} + {λ}_{L}\end{matrix} \qquad ( 1 )$$

where α is the Seebeck coefficient, σ is the electrical conductivity, λₑ is the electronic thermal conductivity, λ_{L} is the lattice (phonon) thermal conductivity, and T is the temperature in Kelvin. The numerator of equation (3.1), α²σ, is called the power factor. There are two types of thermoelectric materials, p-type and n-type; these can be compared to the cathode and anode in a battery respectively. The sign of Seebeck coefficient of a TE material, which is not known a priori of material testing, defines the type. Trial and error method of TE material identification is one of the reasons why “perfect” TE material has not been found.

Currently, efforts in finding thermoelectric material with high ZT have been focused on reducing the lattice thermal conductivity. The lattice thermal conductivity, unlike λₑ, has little affect on the electrical conductivity, and it is determined primarily by scattering of thermally excited elastic waves called phonons. Therefore, theoretically, σ/λ can be maximized by minimizing λ_{L}. Skutterudite family of materials has shown characteristics that conform to the mentioned technique, and significant progress has been made.

To date, commonly available thermoelectric materials like bismuth telluride (Bi₂Te₃), bismuth antimony (BiSb), lead telluride (PbTe), silicon germanium (SiGe), and other related alloys have been identified which have a maximum ZT of 1 or less. Relatively recent studies of barium cobalt antimony (BaₓCo₄Sb₁₂) and other skutterudite compounds have demonstrated medium temperature performance with ZT in excess of 1.2 suggest possibility of achieving higher figure of merit. Also, a new family of oxide materials is also being actively investigated for thermoelectric application since oxides are extremely stable (corrosion resistant) and relatively inexpensive to manufacture. Current oxide thermoelectric material has maximum ZT of 0.78; oxide material has relatively low power factor for power generation application. Clathrates are another family of materials that being examined by number of researchers for cooling application.

The material mentioned above and many others behave in a non-linear manner. The Seebeck coefficient, electrical conductivity, thermal conductivity are all functions of temperature. In fact, magnetic field has been also observed to have significant influence on these variables as well. Commonly used Bi₂Te₃ alloy has relatively high figure of merit in the room temperature range, but its efficiency drops rapidly as temperature moves into exhaust gas temperature. Zinc Antimony (Zn₄Sb₃) on other hand has high figure of merit at 700 K, but has extremely low value at room temperature.

FIG. 5 illustrates an unicouple device in a power generation application. It is comprised of a positive (P-type) and a negative (N-type) thermoelectric bulk material 46 and 48 connected by a hot metal contact 50. A cold metal contact 52 and 54 are respectively coupled to P material 46 and N material 48 opposite metal contact 50, and provide an electrical contact for supplying load current I_{L} to load R_{L}. Contact 50 is exposed to the source of heat (having a heat flux=q_{IN}) to produce a surface temperature T_{H}. Cold contacts 52 and 54 operate at a surface temperature T_{C}, thereby producing a ΔT with contact 50. The efficiency of a unicouple device is stated as:

$$\begin{matrix}η = ( 1 - ξ ) ( \frac{\sqrt{1 + ZT} - 1}{\sqrt{1 + ZT} + ξ} ) , & & ξ = {T}_{C} / {T}_{H}\end{matrix} . \qquad ( 2 )$$

In general, a single unicouple generates power in the milliwatt range. Connecting a number of unicouples in series will form a thermoelectric device having an output power and voltage that can be adjusted for a desired application.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A supplemental energy generating system integrated with an exhaust system of a combustion engine comprising:
a catalytic converter positioned in an exhaust passage of the exhaust system, said converter having a housing enclosing a metal catalytic substrate;
a coolant channel disposed with the housing and having an input and output connected to an externally located cooling system;
a thermoelectric generator element disposed within the housing between the coolant channel and the metal catalytic substrate, the thermoelectric generator element positioned to be in heat exchange relationship with the metal catalytic substrate and the coolant channel, and generate an electric current as a function of the heat exchange; and
a processing system connected to the thermoelectric generator element for processing the electric current to generate an electric power output.

2. The system of claim 1 further comprising a temperature sensor arranged to provide a signal representative of operating temperature of the catalytic converter, wherein the processing system further comprises a controller connected to the temperature sensor, the controller arranged to detect that the temperature of the catalytic converter is below a predetermined temperature and switch off operation of the thermoelectric generator element.

3. The system of claim 1 wherein the processing system further comprises a controller connected to the thermoelectric generator element and arranged to determine that the catalytic converter has reached a light off temperature, and enable the thermoelectric generator element to generate electric current only when the catalytic converter is operating at a temperature above the light off temperature.

4. The system of claim 1 wherein the thermoelectric generator element comprises a plurality of elements electrically connected to generate a desired output power.

5. The system of claim 4 wherein the plurality of thermoelectric generator elements comprises a plurality of elements connected together in parallel.

6. The system of claim 4 wherein the plurality of thermoelectric generator elements comprises a plurality of elements connected together in series.

7. The system of claim 1 wherein the processing system is arranged to monitor temperature of the thermoelectric generator element, and control flow of coolant through the coolant channel as a function of the thermoelectric generator element to maintain a temperature gradiant.
